(19) United States
(12) Patent Application Publication
(10) Pub. No.: US 2014/0330875 A1
(43) Pub. Date: Nov. 6, 2014

(54) METHOD AND SYSTEM FOR PROCESSING DATA FILES USING DISTRIBUTED SERVICES

(71) Applicant: PINKQUO TECHNOLOGIES INC., BRAMPTON (CA)

(72) Inventor: IRFAN GULAMALI, BRAMPTON (CA)

(21) Appl. No.: 13/875,645

(22) Filed: May 2, 2013

(51) Int. Cl. G06F 17/30

(52) U.S. Cl. CPC G06F 17/30194
USPC 707/827

(57) ABSTRACT

A method for processing data files, comprising: storing a data file and a template file in a file system, the template file containing a command identifier for a command for processing the data file, the template file being stored in a directory in a directory path of the data file, the directory path indicating where the data file is stored in the file system; receiving a request for a data file to process from a satellite service; and, forwarding the directory path for the data file to the satellite service in response to the request, the satellite service searching the directory path to locate the data file and the template file, the satellite service calling a program with the command indentified by the command identifier in the template file to process the data file.

### FIELD OF THE INVENTION

This invention relates to the field of data file processing, and more specifically, to a method and system for processing data files using distributed services.

### BACKGROUND OF THE INVENTION

In current datacenters, when large data files (e.g., media files or otherwise) are processed, they are typically accessed from a network device that hosts the files on a file system that can be mounted over the network. These files are accessed over the network by other server computers that also mount or access the file system over the network.

However, systems that process such files are often composed of different components that are supplied by different vendors. As such, users often need to integrate the different components. In addition, such systems often do not meet all the needs of the user. As such, in much the same way that the different components are integrated, the additional features that a user typically needs for these systems over time also need to been integrated. Furthermore, when these systems are integrated, much time is spent managing and maintaining the integration as these systems are scaled.

A need therefore exists for an improved method and system for processing data files. Accordingly, a solution that addresses, at least in part, the above and other shortcomings is desired.

### SUMMARY OF THE INVENTION

According to one aspect of the invention, there is provided a method for processing data files, comprising: storing a data file and a template file in a file system, the template file containing a command identifier for a command for processing the data file, the template file being stored in a directory in a directory path of the data file, the directory path indicating where the data file is stored in the file system; receiving a request for a data file to process from a satellite service; and, forwarding the directory path for the data file to the satellite service in response to the request, the satellite service searching the directory path to locate the data file and the template file, the satellite service calling a program with the command indentified by the command identifier in the template file to process the data file.

In accordance with further aspects of the present invention there is provided an apparatus such as a data processing system, a method for adapting same, as well as articles of manufacture such as a computer readable medium or product and computer program product having program instructions recorded thereon for practising the method of the invention.

### BRIEF DESCRIPTION OF THE DRAWINGS

Further features and advantages of the embodiments of the present invention will become apparent from the following detailed description, taken in combination with the appended drawings, in which:

FIG. 1 is a block diagram illustrating a data processing system in accordance with an embodiment of the invention;

FIG. 2 is an overview block diagram illustrating a distributed file processing system in accordance with an embodiment of the invention;

FIG. 3 is a detailed block diagram illustrating the distributed file processing system of FIG. 2 in accordance with an embodiment of the invention;

FIG. 4 is a screen capture illustrating an exemplary login screen in accordance with an embodiment of the invention;

FIG. 5 is a screen capture illustrating an exemplary system administration screen in accordance with an embodiment of the invention;

FIG. 6 is a screen capture illustrating an exemplary job queue screen in accordance with an embodiment of the invention;

FIG. 7 is a screen capture illustrating an exemplary audit log screen in accordance with an embodiment of the invention;

FIG. 8 is a screen capture illustrating an exemplary metric reporting screen in accordance with an embodiment of the invention;

FIG. 9 is a screen capture illustrating an exemplary completed job archive screen in accordance with an embodiment of the invention;

FIG. 10 is a screen capture illustrating an exemplary trouble shooting screen in accordance with an embodiment of the invention; and,

FIG. 11 is a flow chart illustrating operations of modules within a data processing system for processing data files, in accordance with an embodiment of the invention.

It will be noted that throughout the appended drawings, like features are identified by like reference numerals.

### DETAILED DESCRIPTION OF THE EXEMPLARY EMBODIMENTS

In the following description, details are set forth to provide an understanding of the invention. In some instances, certain software, circuits, structures and methods have not been described or shown in detail in order not to obscure the invention. The term “data processing system” is used herein to refer to any machine for processing data, including the computer systems, wireless devices, and network arrangements described herein. The present invention may be implemented in any computer programming language provided that the operating system of the data processing system provides the facilities that may support the requirements of the present invention. Any limitations presented would be a result of a particular type of operating system or computer programming language and would not be a limitation of the present invention. The present invention may also be implemented in hardware or in a combination of hardware and software.

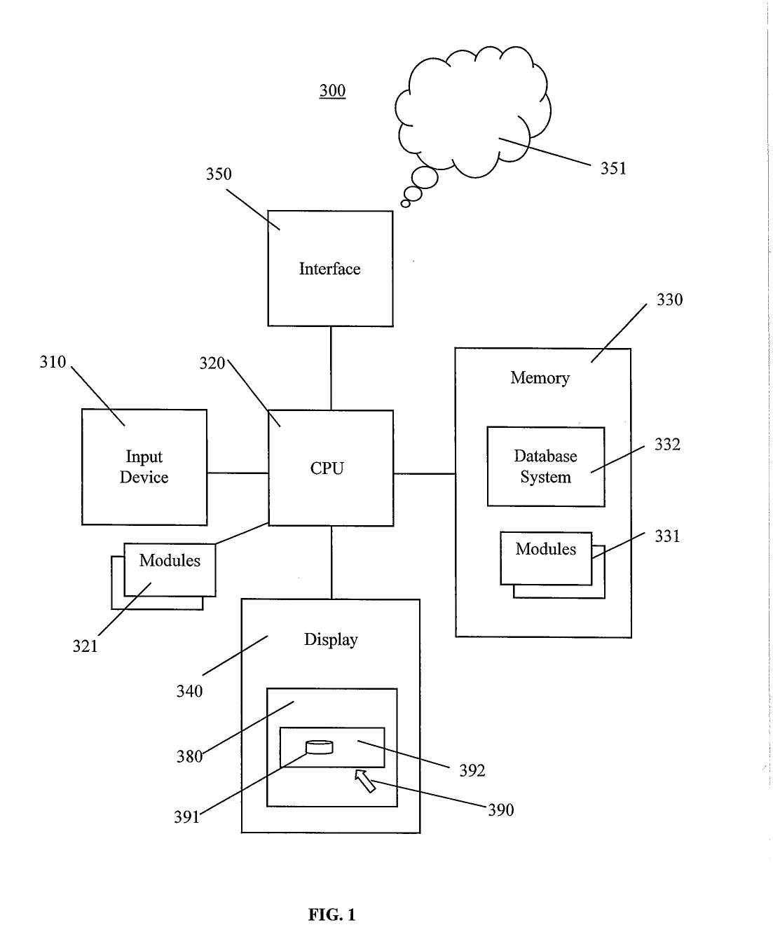

FIG. 1 is a block diagram illustrating a data processing system 300 in accordance with an embodiment of the invention. The data processing system 300 is suitable for data file processing, file management, file storage, and for generating, displaying, and adjusting presentations in conjunction with a user interface or a graphical user interface (“GUI”), as described below. The data processing system 300 may be a client and/or server in a client/server system (e.g., 100). For example, the data processing system 300 may be a server system or a personal computer (“PC”) system. The data processing system 300 may also be a mobile device or other wireless, portable, or handheld device. The data processing system 300 may also be a distributed system which is deployed across multiple processors. The data processing system 300 may also be a virtual machine. The data processing system 300 includes an input device 310, at least one central processing unit (“CPU”) 320, memory 330, a display 340, and an interface device 350. The input device 310 may include a keyboard, a mouse, a trackball, a touch sensitive surface or screen, a position tracking device, an eye tracking device, or a similar device. The display 340 may include a computer screen, television screen, display screen, terminal device, a touch sensitive display surface or screen, or a hardcopy producing output device such as a printer or plotter. The memory 330 may include a variety of storage devices including internal memory and external mass storage typically arranged in a hierarchy of storage as understood by those skilled in the art. For example, the memory 330 may include databases, random access memory (“RAM”), read-only memory (“ROM”), flash memory, and/or disk devices. The interface device 350 may include one or more network connections. The data processing system 300 may be adapted for communicating with other data processing systems (e.g., similar to data processing system 300) over a network 351 via the interface device 350. For example, the interface device 350 may include an interface to a network 351 such as the Internet and/or another wired or wireless network (e.g., a wireless local area network (“WLAN”), a cellular telephone network, etc.). As such, the interface 350 may include suitable transmitters, receivers, antennae, etc. Thus, the data processing system 300 may be linked to other data processing systems (e.g., 101, 500, 501) by the network 351. The CPU 320 may include or be operatively coupled to dedicated coprocessors, memory devices, or other hardware modules 321. The CPU 320 is operatively coupled to the memory 330 which stores an operating system (e.g., 331) for general management of the system 300. The CPU 320 is operatively coupled to the input device 310 for receiving user commands or queries and for displaying the results of these commands or queries to the user on the display 340. Commands and queries may also be received via the interface device 350 and results may be transmitted via the interface device 350. The data processing system 300 may include a datastore, file management system, or database system 332 for storing data and programming information. The database system 332 may include a database management system and a database (e.g., 400) and may be stored in the memory 330 of the data processing system 300. In general, the data processing system 300 has stored therein data representing sequences of instructions which when executed cause the method described herein to be performed. Of course, the data processing system 300 may contain additional software and hardware a description of which is not necessary for understanding the invention.

Thus, the data processing system 300 includes computer executable programmed instructions for directing the system 300 to implement the embodiments of the present invention. The programmed instructions may be embodied in one or more hardware modules 321 or software modules 331 resident in the memory 330 of the data processing system 300 or elsewhere (e.g., 320). Alternatively, the programmed instructions may be embodied on a computer readable medium (or product) (e.g., a compact disk (“CD”), a floppy disk, etc.) which may be used for transporting the programmed instructions to the memory 330 of the data processing system 300. Alternatively, the programmed instructions may be embedded in a computer-readable signal or signal-bearing medium (or product) that is uploaded to a network 351 by a vendor or supplier of the programmed instructions, and this signal or signal-bearing medium may be downloaded through an interface (e.g., 350) to the data processing system 300 from the network 351 by end users or potential buyers.

A user may interact with the data processing system 300 and its hardware and software modules 321, 331 using a user interface such as a graphical user interface (“GUI”) 380 (and related modules 321, 331). The GUI 380 may be used for monitoring, managing, and accessing the data processing system 300. GUIs are supported by common operating systems and provide a display format which enables a user to choose commands, execute application programs, manage computer files, and perform other functions by selecting pictorial representations known as icons, or items from a menu through use of an input device 310 such as a mouse. In general, a GUI is used to convey information to and receive commands from users and generally includes a variety of GUI objects or controls, including icons, toolbars, drop-down menus, text, dialog boxes, buttons, and the like. A user typically interacts with a GUI 380 presented on a display 340 by using an input device (e.g., a mouse) 310 to position a pointer or cursor 390 over an object (e.g., an icon) 391 and by selecting or “clicking” on the object 391. Typically, a GUI based system presents application, system status, and other information to the user in one or more “windows” appearing on the display 340. A window 392 is a more or less rectangular area within the display 340 in which a user may view an application or a document. Such a window 392 may be open, closed, displayed full screen, reduced to an icon, increased or reduced in size, or moved to different areas of the display 340. Multiple windows may be displayed simultaneously, such as: windows included within other windows, windows overlapping other windows, or windows tiled within the display area.

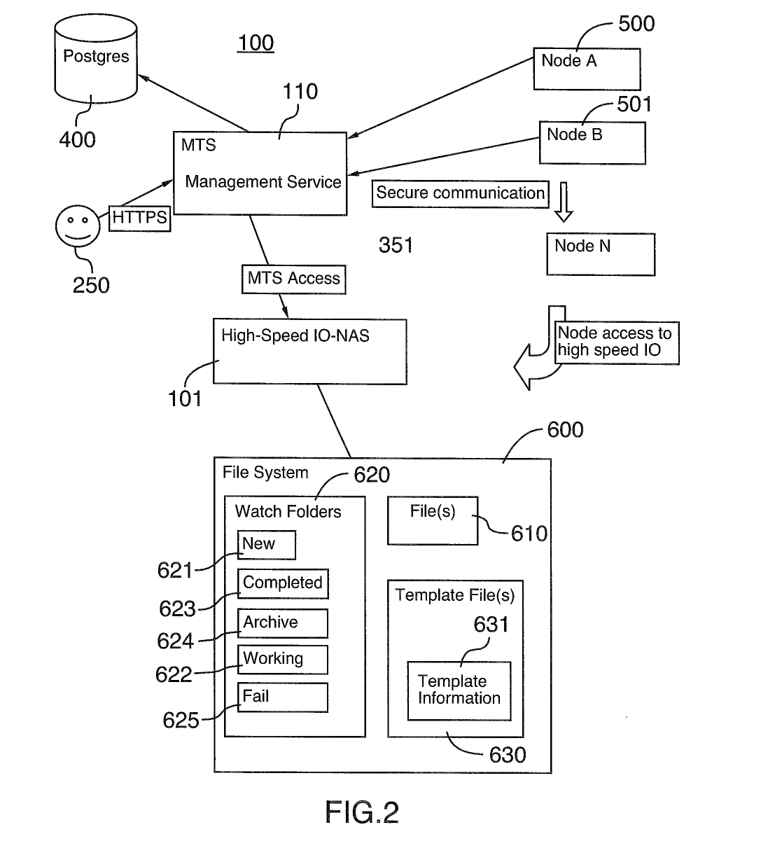

FIG. 2 is an overview block diagram illustrating a distributed file processing system 100 in accordance with an embodiment of the invention. The present invention provides a system and method for processing large numbers of files 610 in a distributed fashion. The system 100 includes a media transform system (“MTS”) service 110 that is highly scalable and configurable. The MTS service 110 includes a web or HTTP service 150 for management of the system 100 and a database system 400, 332 for generating file processing jobs 441, tracking jobs 441, and distributing jobs 441 across a network 351. The files 610 to be processed are monitored, read and written across the network 351 using a network storage file system 600 and execution on the files 610 is performed through a template system by multiple client nodes 500, 501. According to one embodiment, the system 100 automates the use of FFMPEG™ for converting media files 610 to different formats. For reference, FFMPEG™ is a cross-platform solution to record, convert and stream audio and video files. According to one embodiment, the MTS service 110 runs on Linux™ and communicates with client nodes 500, 501 which also run a client service on Linux™. The client service on each node 500 reaches out to the MTS service 110 and requests a job 441 for processing. In some cases, the MTS service 110 reaches out to the nodes 500, 501. The MTS service 110 and the nodes 500, 501 have access to high-speed input-output (“IO”) network attached storage (“NAS”) 101 which may be used to implement the network storage file system 600.

In general, the database 400 of the MTS service 110 is used to track files 610 being processed and for reporting on which node 500, 501 is servicing the processing job 441 as well as when it completes a task. The MTS service 110 coordinates communication and access to the system 100. The web or HTTP service 150 allows users to monitor jobs 441. The MTS service 110 also sends jobs 441 to nodes 500, 501 for processing. The nodes 500, 501, also referred to as satellites (“SATS”) below, request jobs 441 from the MTS service 110. Based on the number of processor cores 320 that a node 500 is running, the node 500 will attempt to service that number of jobs 441 in parallel to maximize core count. Once a job 441 is received by a node 500, the node 500 attempts to find a template file 630 on the high-speed IO NAS 101 which allows it to determine what format, bitrates, codec, etc. to execute on the file 610 while calling FFMPEG™. The template file 630 closest (i.e., in the directory tree structure) to the file 610 on the high-speed IO NAS 101 is used to execute on the file 610.

Each node 500 may be thought of as a server system like the one the MTS service 110 runs on. The nodes 500 are referred to as such to identify them as clients of the MTS service 110 which may be server based. The high-speed IO NAS 101 may be any vendor specific solution that both the MTS service 110 and the nodes 500 may read media files 610 from.

The MTS service 110 and each SAT service 500 are configured at start-up by way of a MTS configuration file 260 and a SAT configuration file 570, respectively. Once the services are installed, for the MTS service 110, the settings of the default ports are confirmed or changed if required. The MTS service 110 may use a sample self-signed certificate in privacy enhanced mail (“PEM”) format.

This may be exchanged with a user's corporate signed certificate if desired. This is the certificate that is presented to the browser when browser clients 250 connect to the web or HTTP service 150 for starting services and for managing a job queue. With the exception of the certificate, the SAT service 500 also has a similar configuration file 570 which has specific information concerning connecting to the Internet Protocol (“IP”) address and port of the MTS service 110. Both the SAT service 500 and the MTS service 110 have a setting for a number of watch folders 620 where digital files (e.g., media files) 610 will be monitored for changes and be written to during processing. On the MTS service 110 side, a tool (e.g., “mts setup”) is provided for configuring the databases 400, 600 that the MTS service 110 will be connecting to. The tool may also be used to create the watch folders 620 in the watch path to be used. Passing the watch folder path to the mts setup tool may create the following directories in the watch folder path: new 621, working 622, completed 623, archive 624, and fail 625. Finally, a shared password setting for the MTS service 110 and the SAT service 500 may be used to allow for secure communications. For example, communications may be implemented using a custom fast cipher block allowing for 160 bit secure communications.

Template files 630 (“template.cnf”) are used to generate processing jobs 441 which are maintained in a job queue. A template file 630 is used to determine how a file 610 will be formatted and executed on. The template file 630 may be placed in multiple locations in the new watch folder 621. Each template file 630 in the new watch folder 621 may override template files 630 at the top of the new watch folder directory tree. What this means in that a template file 630 that is in a folder closer to a folder where a media file 610 is stored, may override template files higher up in the directory tree. For example, for a media file 610 entitled “small short independent movie.mov” in the path “/storage/MEDIA/new/downloaded files/small short independent movie.mov”, the template file 630 “template.cnf” in the “new” folder in the path “/storage/MEDIA/new/template.cnf” would be overridden by the template file 630 “template.cnf” in the path “/storage/MEDIA/new/downloaded files/template.cnf”. The following is a listing for exemplary template information 631 included in a template file 630 (“template.cnf”) for video/audio encoding:

template.cnf
# the following outlines a sample template
# for video/audo encoding
# NOTE THAT TEMPLATES ARE ALWAYS NAMED: template.cnf
output_container=avi
video_codec=libx264
audio_codec=mp3
framerate_per_second=
audio_bitrate=22050
video_bitrate=700k
video_width=720
video_height=340
# job details read by MTS for generating job details
#note that you can only have one entry for GROUP and PRIORITY
#in your template file and this needs to be placed in the section of your
#first output file's settings.
# PRIORITY= LOW | MEDIUM | HIGH
GROUP=ALPH
PRIORITY=LOW
#a tag uniquely identifies part of a job
#you could have multiple outputs from a job so this tag
#is uniquely used in your template file to identify one of the outputs
#from your single template, it's imperative that this be included
#in the template when having multiple output streams
#this will be tacked onto the file name for output
TAG=DESKTOP
#this tag below separates the multiple output file
#settings in the template file
#after this tag, the second set of settings for the second
#output file will follow
CMD;;
#settings to output only the audio of the video
#as an mp3 file
output_container=mp3
video_codec=
audio_codec=mp3
framerate_per_second=
audio_bitrate=22050
video_bitrate=
video_width=
video_height=

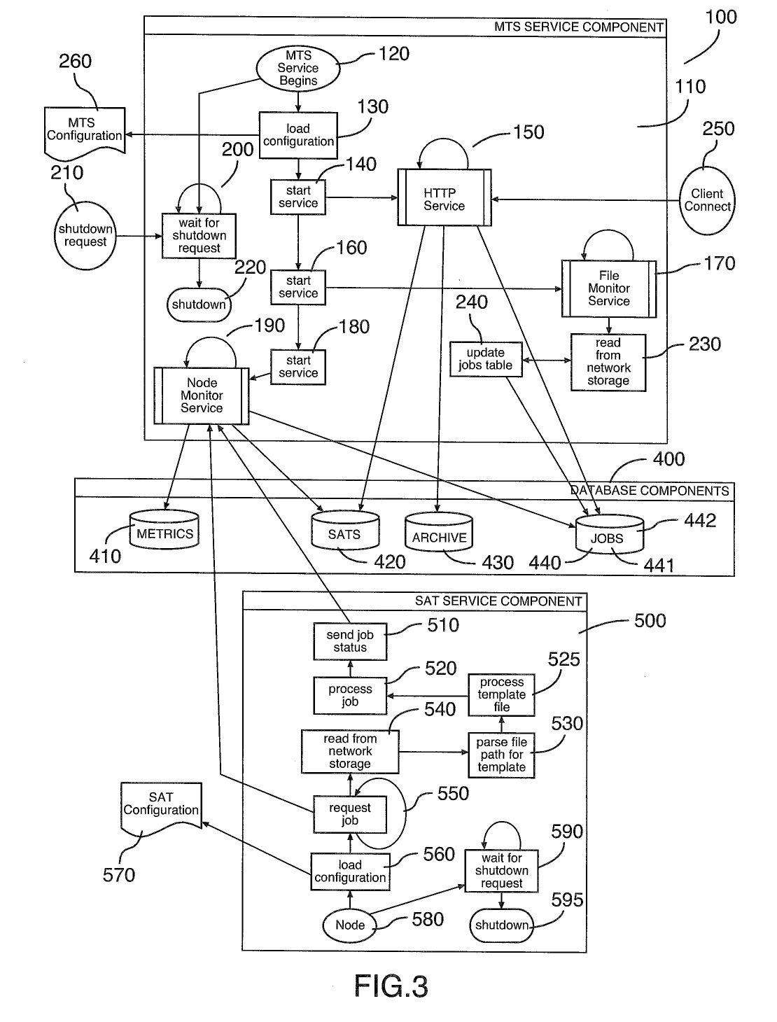

FIG. 3 is a detailed block diagram illustrating the distributed file processing system 100 of FIG. 2 in accordance with an embodiment of the invention. As mentioned above, the system 100 includes a media transform system (“MTS”) service 110 component, database components 400, at least one node or satellite (“SAT”) service 500 component, and a file system 600 component. The MTS service 110 manages the monitoring of files 610 written to the network storage file system 600 or local file system and the distributing of the processing of the files 610 across the network 351 to other computer systems or nodes 500, 501. However, this distribution of processing is not a requirement and all of the components of the file management system 100 may be widely distributed or, indeed, centralized in a single data processing system 300. For example, the components 110, 400, 500, 600 shown in FIG. 1 may represent software modules 331 and/or hardware modules 321 within the data processing system 300 of FIG. 1. Alternatively, one or more of the components 110, 400, 500, 600 may be configured similarly to the data processing system 300 of FIG. 1. The network storage file system 600 may be “cloud-based” and include a number of data processing system 300 distributed over a network 351.

According to one embodiment, the MTS service 110 begins 120 operations by loading and reading 130 a MTS configuration file 260 that describes how the service is to operate. For example, the MTS configuration file 260 may describe the network ports that should be listened to and connected on for a data processing system 300, as well as the network addresses for those connections. Additionally, the MTS configuration file 260 may describe the security information for secure sockets layer (“SSL”) connections and any other security information required for secure network communications. Furthermore, the MTS configuration file 260 may describe how many threads should be running. Finally, the MTS configuration file 260 may describe the database connection settings used in accordance with application requirements. According to one embodiment, the MTS configuration file 260 may also describe additional information concerning application settings required for MTS service 110 changes. For example, if there are additional services that need to run as part of the MTS service 110, those additional services may be described and configured using the MTS configuration file 260 which is read 130 during start-up 120.

Once the MTS service 110 starts-up 120, it takes the configuration settings received 130 from the MTS configuration file 260 and starts 140, 160, 180 additional services 150, 170, 190, accordingly. One of the services which it starts 140 is the web or HTTP service 150 which allows a user at a client connect system 250 to login and manage other users as well as jobs 441 which are created by the system 100 when files 610 are monitored and read from the network storage file system 600. The HTTP service 150 may access databases 420, 430, 440 for reporting information to the user.

Another service which is started 160 during start-up of the MTS service 110 is a file monitoring service 170. The file monitoring service 170 monitors files 610 written to the file system 600, stores file information in various databases 440, and tracks the progress of files 610 copied to the file system 600. After a predetermined idle period, the file monitoring service 170 determines that a file 610 in the file system 600 is ready to be processed. In addition to reading in the metadata (e.g., file size, file path, etc.) for the file 610, the file monitoring service 170 searches file path directories for a template file 630 describing the priority and group name for which a job 441 associated with the file 610 should be assigned. The file monitor service 170 monitors files 610 entering the new watch folder 620 located at the file system 600 where new files 610 are placed for processing.

The final service which is started 180 during start-up of the MTS service 110 is a node monitoring service 190 which listens for requests 550 for jobs 441 from nodes 500, 501 and for status updates 510 of jobs 441 that have been sent out to the nodes 500, 501 on the network 351. While FIG. 3 shows only one connected node 500, many such nodes 500, 501 may be included in the system 100 as shown in FIG. 2.

Operations of the MTS service 110 may be shutdown 220 upon receiving 200 a shutdown request 210.

Upon start-up 580 of the SAT service 500 for a node 500, a SAT configuration file 570 is loaded 560. The SAT configuration file 570 may include a relative path for files 610 stored in the file system 600. The SAT service 500 is a network service or node which processes 520 jobs 441 and sends 510 updates back to the MTS service 110. When the SAT service 500 connects to the node monitoring service 190 of the MTS service 110, it requests 550 a job 441 over the network 351. When the request is received by the node monitoring service 190, the service 190 does a lookup in a SATS database 420 which describes a group name to which the SAT service 500 belongs. It then selects a job 441 from the JOBS database 440 where a job 441 is assigned to the same group name to which the SAT service 500 belongs. If the job 441 is ready to be worked on, it then sends a job ID for the job 441 and a path 442 to the file 610 to the SAT service 500. The path 442 information may be stored in the JOBs database 440.

When the SAT service 500 receives the job 441, it looks up 540 the relative file path it has been provided (e.g., via the SAT configuration file 570 or via the MTS service 110) and begins to parse or search 530 the relative path for a template file 630 which describes how it will execute on the file 610 to be processed 520. According to one embodiment, the SAT configuration file 570 may include the relative path for the file 610 and the MTS configuration file 260 may include the absolute path for the file 610. The template file 630 may have been initially parsed by the MTS service 110.

Next, a folder is created with the job ID as the folder name under a working watch folder 622. The working watch folder 622 will be written to as the file 610 is being processed 520. When the SAT service 500 begins processing 520 the file 610, it generates and monitors a system call (e.g., a FFMPEG™ call) obtained from processing 525 the template file 630. The system call performs 520 a specified command (or commands) on the file 610 at the file system 600 to complete the job 441. The system call includes the required template information 631 read 525 from the template file 630. The template information 631 may identify the specified command, how the specified command needs to start for the file 610, and any command arguments used for any commands included in the specified command. When the specified function is completed 520 on the file 610, the SAT service 500 moves the folder with the job ID in the working watch folder 622 to a completed watch folder 623 and then sends 510 a status message to the MTS service 110 including metric information relating to, for example, how long the specified command took to complete. If there are additional jobs 441 to execute, the SAT service 500 will request 550 another job 441. If no job 441 is yet available, the SAT service 500 will wait for a predetermined period of time before it tries requesting 550 another job 441.

Operations of the SAT service 500 may be shutdown 595 upon receiving 590 a shutdown request.

Once the MTS service 110 receives 510 the job status information from the SAT service 500, it updates the status of the job 441 in a JOBS table or database 440. In addition, the MTS service 110 updates a METRICS table or database 410 which records how long the specified command took to complete, etc. The MTS service 110 also archives completed jobs 441 when requested by a user via the web or HTTP service 150 by saving them in an ARCHIVE database 430. Jobs 441 in the JOBS table 440 with completed statistics may also be archived in the ARCHIVE database 430. In addition to this, the original files 610 in the new watch folder 621 may be moved to an archive watch folder 624 at the file system 600. Furthermore, files 610 for which processing failed for some reason may be moved to a fail watch folder 625 at the file system 600.

As mentioned above, the file monitoring service 170 monitors changes in files 610 which enter the system 100 and are (pre) stored in the file system 600 along with template files 630. The file monitoring service 170 accesses watch folders 620 which are folders specified for files 610 that enter the system 100. Each file parsed has a specific file extension that the system 100 will use. According to one embodiment, the files extensions (e.g., .mov, .avi, .mpg, .mp3) may indicate that a data file 610 is a media file. These file extensions are hard coded or loaded from the MTS configuration file 260. In addition to parsing these specific file types, template files 630 which are used to configure files 610 and to configure and specify commands that will be executed on the files 610 are located by searching for specific template files 630. These template files 630 are distributed throughout the directories and subdirectories of the watch folders 620 in the files system 600.

The template file 630 associated with each file 610 is determined by locating the closest template file 630 to that file 600 as stored in the watch folders 620 at the file system 600. The system 100 searches the full path of the file 610 for the template file 630 as described above. As another example, if the full path 442 of the file 610 is “/home/media/new/downloads/shortfilms/moviefile mpg”, the paths are searched in reverse order until a template file 630 is found or until only the watch folder path is left. In this example, the watch folder's path is “/home/media/new/”. The first search path used is therefore “/home/media/new/downloads/shortfilms/”. The next search path used is “/home/media/new/downloads”. And the final search path used is “/home/media/new/”. Thus, if a template file 630 is found in the closest “shortfilms” folder, which is the closest file in the path 442 to the “moviefile.mpg” file 610, then that template file 610 will be selected. When the SAT service 500 receives a job 441 to work on, it parses 530 the file path 442 in this manner to find the template file 630 associated with the file 610.

As another example, the following is a listing for exemplary template information 631 included in a template file 630:

#this is a comment below is a command
x=/usr/bin/cp
2={file}
1=-p
3={file}.txt
special_property=This is a special value
CMD;;
x=/usr/sbin/chmod
1=go=---
2={file}

The above template information 631 includes a command to copy a file 610 and then set the permission on the file 610. The first line is a comment and the second line identifies a command prefixed with “x” and separated by the “=” sign which assigns the value to the property. The assignment character could also be any other ASCI character deemed as the assignment operator of the property or command. In some cases, if the property is prefixed by a number, the number may indicate the order in which the property needs to be assigned to the command. In some cases, the number may be assigned a value which could either be a parameter flag or a parameter value that may be a file or a user command value. The tag “{file}” is a special property that indicates where the file path 442 will be indicated. In some cases, the value in the template 631 may simply be a property which internally gets turned into a parameter which is passed to a command wrapper. The special tag “CMD;;” indicates where the first command ends and that the next command's settings will follow. This allows one template file 630 to have multiple commands included within it.

A command wrapper may be used to add one more step before calling a command (e.g., making a system call to a FFMPEG™ command), which has been parsed from the template information 631. The command wrapper monitors the system call and reports back to the SAT service 500 with respect to whether the command was executed successfully or not. The command wrapper may return a process ID for the system call and places the result of that system call in a temporary file “(/tmp/<pid>.chk)”. When the temporary file is placed on the temporary file path, it means that the command (i.e., template command) has been completed and within the file is the status of whether the command was successful or not. Since the SAT service 500 made a call to the command wrapper which made the call to the template command and reported the process, the SAT service 500 monitors the temporary file waiting for it to be created with a status indicating when the process was completed. Upon reading the status, the SAT service 500 cleans up the temporarily file by removing the /tmp/<pid>.chk.

According to one embodiment, template files 630 may be retrieved from a database (e.g., 400). The file path may be used as a primary key and the resource template file attached to that primary key may then be read in full into computer memory, and then parsed in a similar fashion to make a system call.

According to one embodiment, a local file system (e.g., 332) may be used instead of a network file system 600. This would be similar to a system with network storage. A local file system may be used in cases where the system is contained and no network file system is required. This may be the case if the client (i.e., SAT service 500) and server (i.e., MTS service 110) are running on the same data processing system 300, given that the system 300 has the requisite computing power.

According to one embodiment, a user determines where template files 630 and data files 610 are stored in the file system 600. In particular, the user determines a strategy for how the file system 600 will be structured.

According to one embodiment, with respect to when the data and template files 610, 630 are stored in the file system 600, the template files 630 should already be in the file system 600 as laid out in the strategy that the user has determined as well as the folder structure and how the files 610, 630 will be placed in the different folders of the folder structure. The template files 630 need to be in place before the data files 610 are placed on the system 600. The data files 630 may be placed on the system 600 in real-time when the data files 630 are transferred to the system 600.

According to one embodiment, the editing and placing of the template files 630 in the directory structure may be performed and managed by the HTTP service 150 via the client connect 250 interface.

According to one embodiment, as described above, the SAT configuration file 570 specifies the path (or at least the relative path) in addition to the MTS configuration file 260. In particular, both the SAT service 500 and the MTS service 110 need to read the same file structure on the network. The base path may appear differently on the SAT service 500 and the MTS service 110. This is because the SAT service 500 and the MTS service 110 may have different folder structures. If, for example, the network file structure includes new, failed, completed, working, and archive folders, the MTS service 110 “mounts” the network file structure under the folder /usr/local/network filesystem/, and the SAT service 500 mounts the network file structure under the folder /home/network filesystem/, then the base path is different for both the SAT service 500 and the MTS service 110. The SAT service's base path is then /home/network filesystem/ and the MTS service's base path is then /usr/local/network filesystem/. On Linux, when one mounts a network file system, one attaches the network folders to a local folder on the system. So this means that for the MTS service 500 to see the (new, failed, completed, working, archive) folder structure, it would have to go to the base path of /usr/local/network filesystem/ and for the SAT service 500 it would be /home/network filesystem/. In addition, when the MTS service 110 communicates the file path to the SAT service 500, it communicates a path that is relative to the network path and not the mount point (i.e., basepath of the MTS service 110). That is to say, it doesn't communicate the basepath along with the file path to the SAT service 500. It is then the SAT service's responsibility to use its own basepath (i.e., mount point of the network file structure) and prefix its own basepath to that of the file path communicated thereby completing the file path and allowing the SAT service 500 to access the file. In this sense, there is no file searching as the SAT service 500 knows directly where to read the file from.

According to one embodiment, the system call referred to above is a call to a command line program (e.g., ./ffmpeg -i file.mpg outputfile.avi). In particular, the SAT service 500 may call “ffmpeg” by making a system call which is a “linux function library call” which then makes a call to FFMPEG™. The implication here is that “ffmpeg” may be called directly without having to know the underlying implementation (e.g., functions) of FFMPEG™. As such, since the SAT service 500 makes a system call to FFMPEG™, it is only loosely coupled to FFMPEG™. As such, if there are changes to the FFMPEG™ code or there are updates to that code, the operations of the SAT service 500 are not affected. In other words, the operations of the SAT service 500 are not directly tied to FFMPEG™ and FFMPEG™ need not be included in the SAT service 500.

With respect to user management of the system 100, a number of input and reporting screens are provided for presentation to a user on a display 340 of the client 250, MTS service 110, and/or SAT service 500 systems 300. These screens are described in the following.

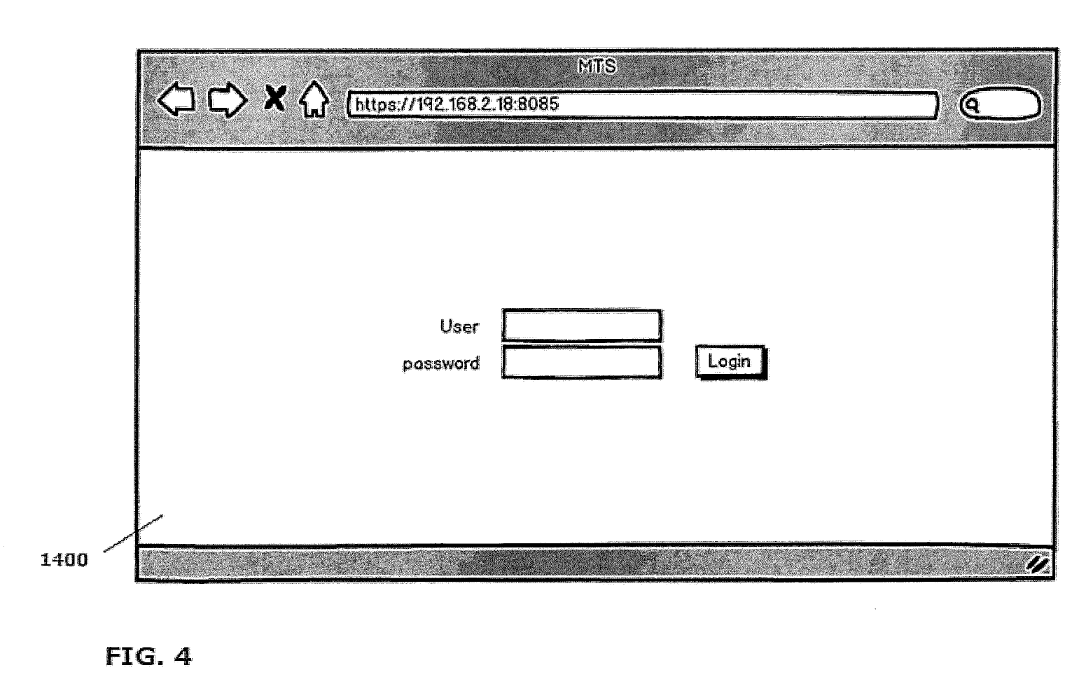

FIG. 4 is a screen capture illustrating an exemplary login screen 1400 in accordance with an embodiment of the invention. The login screen 1400 may be presented to both the administrator of the system 100 and the users of the system 100. According to one embodiment, the web or HTTP service 150 communicates using a secure channel (e.g., SSL).

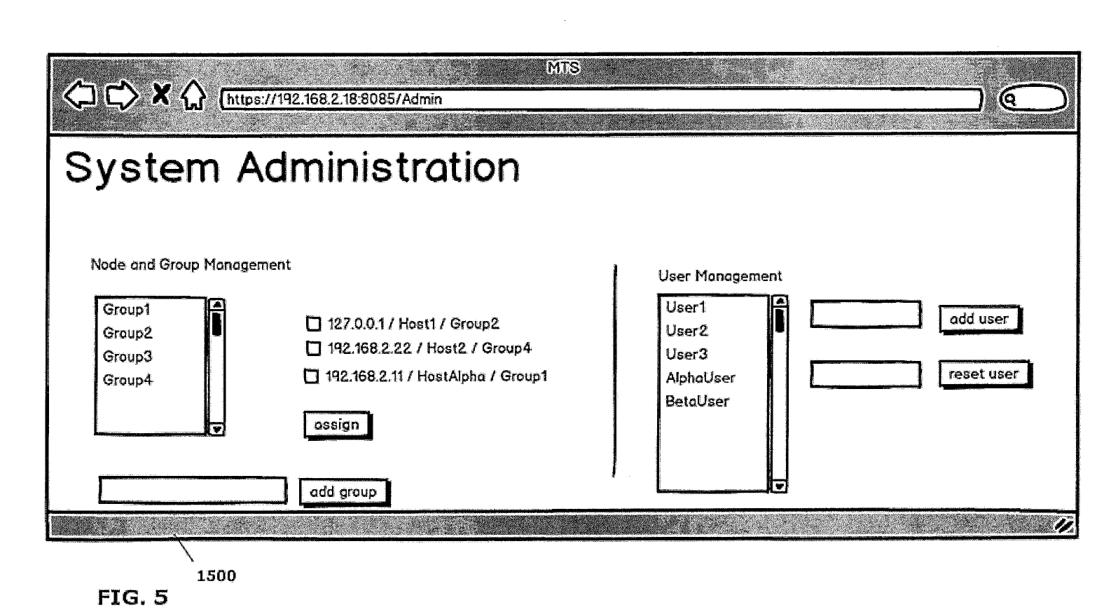

FIG. 5 is a screen capture illustrating an exemplary system administration screen 1500 in accordance with an embodiment of the invention. The system administration screen 1500 may be presented to an administrator once the administrator has logged into the MTS service 110. The MTS service 110 allows the administrator to create groups to which they may assign connecting SAT services 500 for requesting jobs 441. Users of the MTS service 110 may also be created and have their passwords set/reset using this screen 1500. Finally, completed jobs in the system 100 may also be periodically archived using such an administration screen.

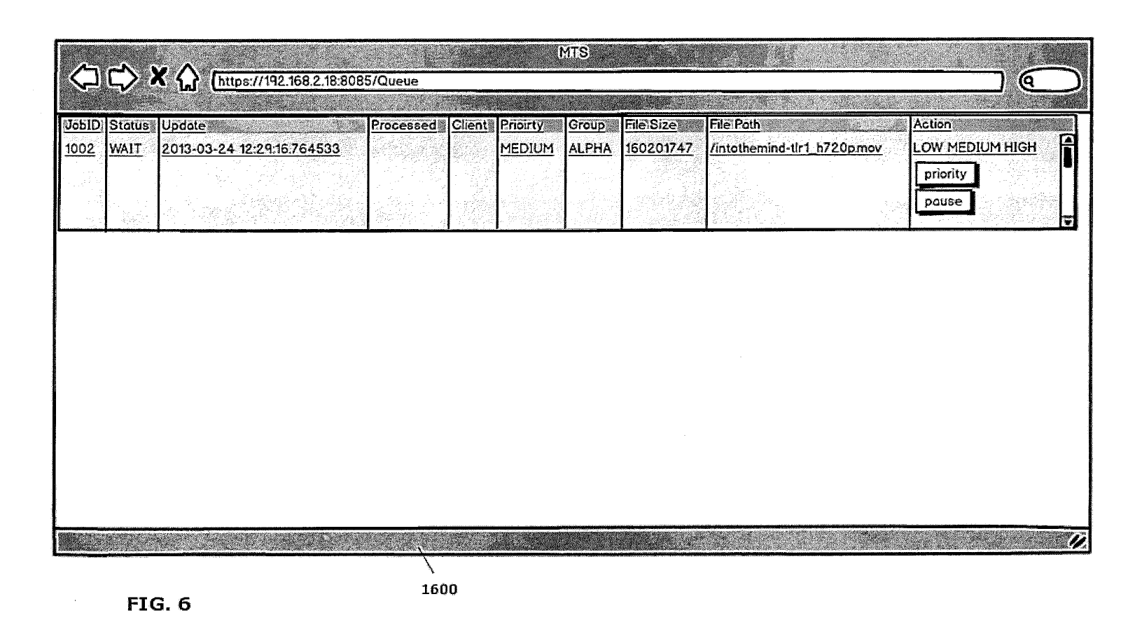

FIG. 6 is a screen capture illustrating an exemplary job queue screen 1600 in accordance with an embodiment of the invention. The job queue screen 1600 may be presented to users when they login to the MTS service 110. A user may assign a priority to a job 441 that is unassigned, and sitting in the job queue waiting to be assigned. Jobs 441 that enter the system 100 are set with a status of, for example, “STAGE” and they then may be monitored for changes (e.g., file size changes) by the system 100. Once these changes appear to be stagnant for, say, 15 minutes, they are ready for processing. The state of the job 441 is then changed to, for example, “WAIT” at which point a connecting SAT service 500 with an assigned group that matches the job's group, will then be sent the job 441 to process. If for whatever reason a user wishes to pause a job 441 in the job queue before it is assigned, this is also provided for.

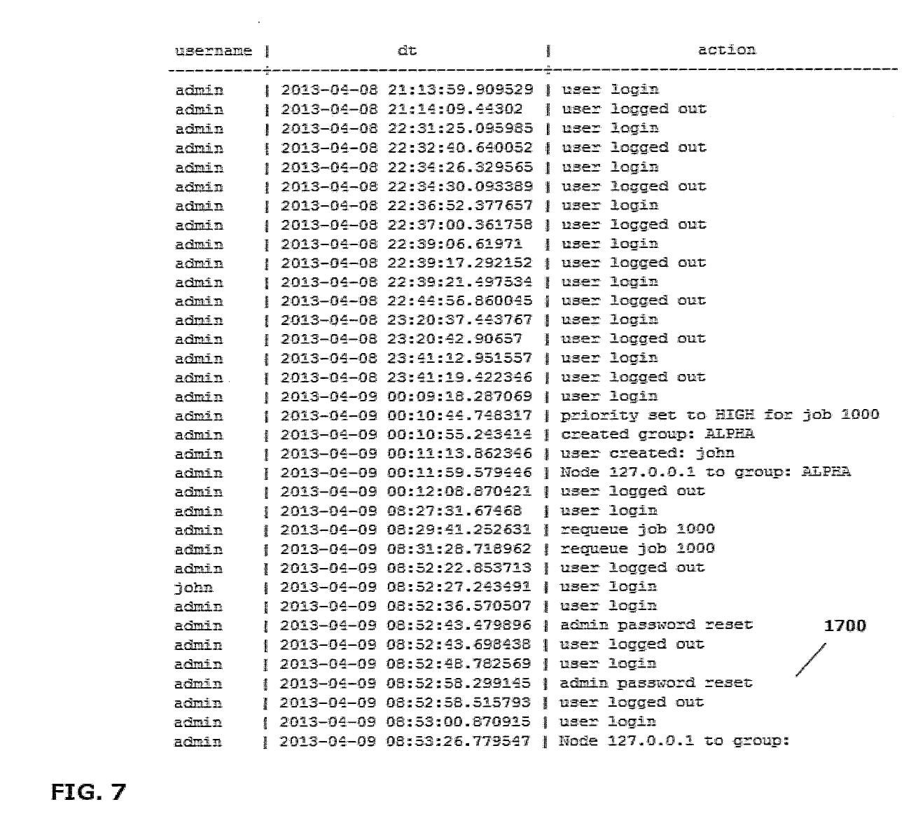

FIG. 7 is a screen capture illustrating an exemplary audit log screen 1700 in accordance with an embodiment of the invention. The MTS service 110 may track user actions on the system 100 by way of an audit log table such as that shown in the audit log screen 1700.

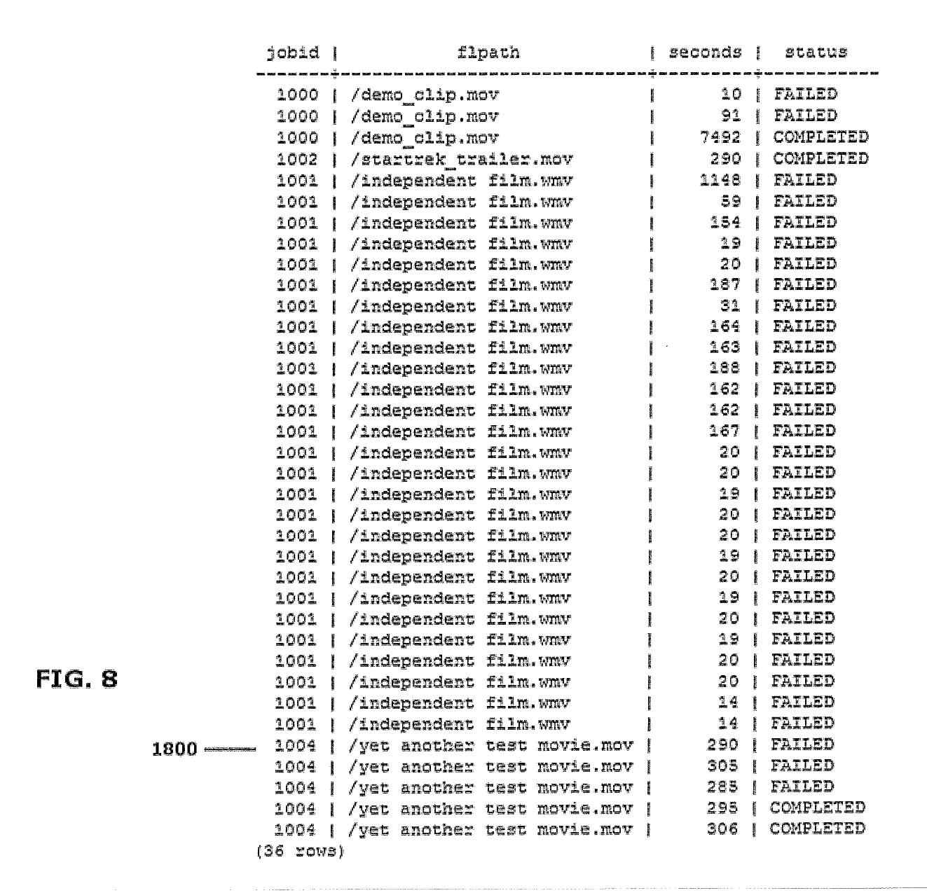

FIG. 8 is a screen capture illustrating an exemplary metric reporting screen 1800 in accordance with an embodiment of the invention. The MTS service 110 may track metrics for completed jobs down to the second. Such metrics may be presented to a user on a metric reporting screen 1800 such as shown in FIG. 8.

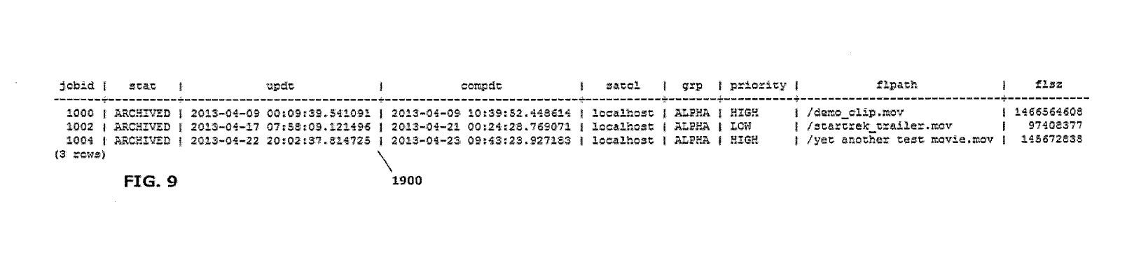

FIG. 9 is a screen capture illustrating an exemplary completed job archive screen 1900 in accordance with an embodiment of the invention. The MTS service 110 may archive a history of completed jobs in a “jobs_arc” table such as that shown in the completed job archive screen 1900.

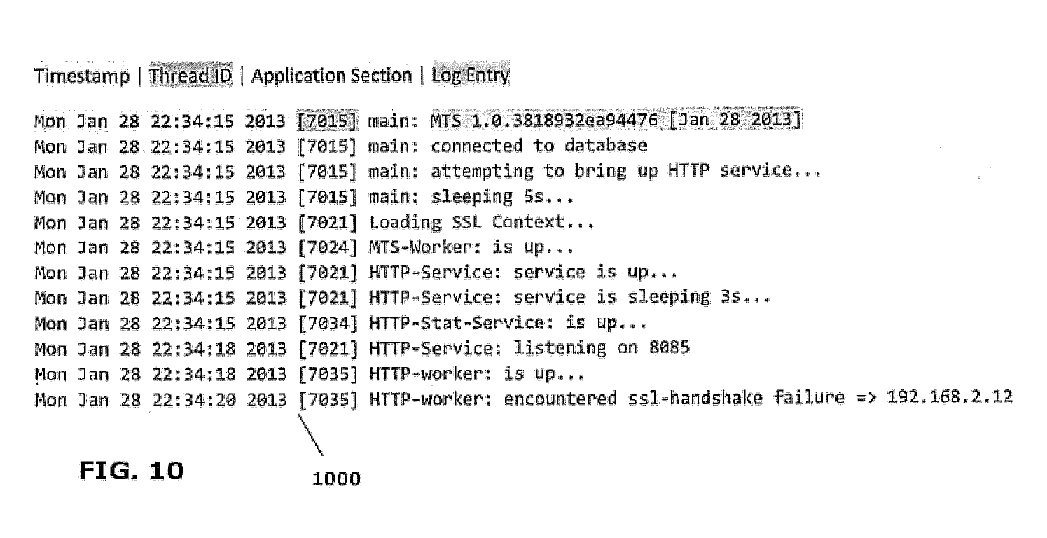

FIG. 10 is a screen capture illustrating an exemplary trouble shooting screen 1000 in accordance with an embodiment of the invention. Most troubleshooting tasks may be executed by inspecting the logs of a given service (i.e., either the MTS service 110 or a SAT service 500). Logs may be written in the path that each service is configured to write their logs to. If an error is encountered, a log entry may usually indicate so with a key word such as “error” and in some cases a tag such as “[E]”. This helps with parsing large logs and in helping filter through all of the information down to the pertinent information that one is looking for while troubleshooting. The trouble shooting screen 1000 of FIG. 10 presents exemplary log entries for either the MTS or SAT services 110, 500.

The above embodiments may contribute to an improved method and system for processing data files 610 and may provide one or more advantages. First, the system 100 may process a large numbers of data files 610 in a distributed fashion. Second, because processing in the system 100 is distributed, the system 100 may be readily scaled. Third, the system 100 does not use its own code for processing files 610. Rather, it uses available libraries of existing commands and code (e.g., a FFMPEG™) to process files 610 without modifying that code. Fourth, because a distributed fashion for processing data files is used, the processing of files is spread across multiple machines which improves file processing efficiency and speed. For example, ten computers working on ten files in parallel is a lot faster than having one machine processing ten files. Fifth, because existing commands are used, the MTS service 110 functions as a true management system allowing the user to customize the system for their needs. In addition, since FFMPEG™ is open source and already available on most Linux systems, the present invention empowers users to make use of FFMPEG™ in a distributed fashion. Furthermore, since existing commands are used, the MTS service 110 and the SAT service 500 remain small and efficient allowing for the processing of the data files to claim more of the CPU resources in order to process data more quickly. Sixth, the use of templates for both configuration and command processing simplifies management of the system. Dynamically finding the right template for the file to be processed allows for overriding templates. For example, a file may be transferred alongside its template and in real time which allows one to override the default template used. Seventh, JO and resource strains on the file system 600 are reduced. In particular, only the MTS service 110 searches for files (high IO but limited to the MTS service) and the path and file structures relative to the file system 600 are communicated to the SAT service 500 in a way that allows them to read the file directly without having to search for it in the various watch folders. In addition, the SAT service 500 has a unique way of finding the template file in the file system 600 given the file path communicated to it which allows the use of overriding templates and the use of the structure of the file system in a hierarchical fashion. This allows for reduced IO on the file system 600.

Aspects of the above described method may be summarized with the aid of a flowchart.

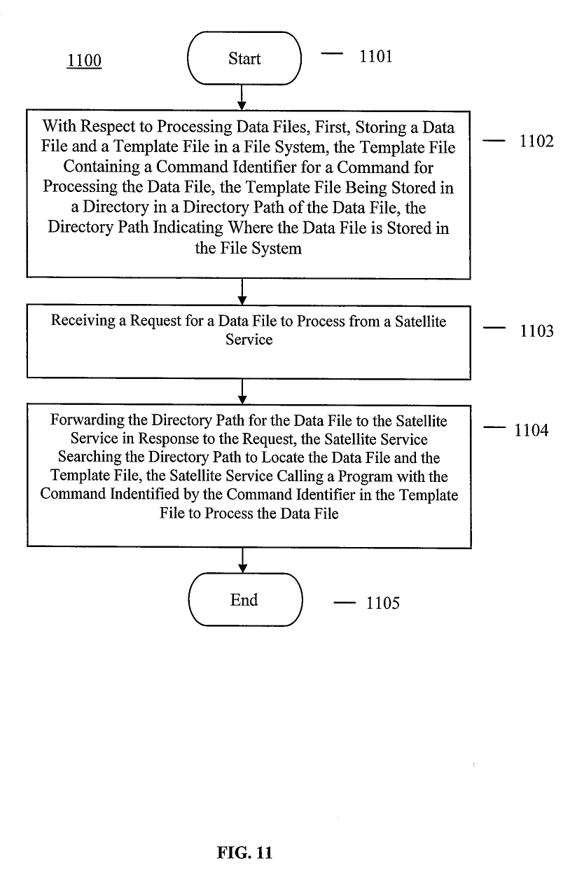

FIG. 11 is a flow chart illustrating operations 1100 of modules (e.g., 331) within a data processing system (e.g., 300) for processing data files 610, in accordance with an embodiment of the invention.

At step 1101, the operations 1100 start.

At step 1102, a data file 610 and a template file 630 are stored in a file system 600, the template file 630 containing a command identifier (e.g., template information) 631 for a command for processing the data file 610, the template file 630 being stored in a directory in a directory path 442 of the data file 610, the directory path 442 indicating where the data file 610 is stored in the file system 600.

At step 1103, a request for a data file to process 550 is received from a satellite service 500.

At step 1104, the directory path 442 for the data file 610 is forwarded to the satellite service 500 in response to the request 550, the satellite service 500 searching the directory path 442 to locate the data file 610 and the template file 630, the satellite service 500 calling a program with the command indentified by the command identifier 631 in the template file 630 to process the data file 610.

At step 1105, the operations 1100 end.

The above method may further include receiving an indication 510 from the satellite service 500 when the command has been completed. The data file 610 may be a media file and the command may be a media file conversion command. The method may further include receiving the data file 610. The program may be a command line program. The command line program may be an external media file conversion program (e.g., FFMPEG™). The request may be received and the directory path 442 may be forwarded by a management service (e.g., MTS service) 110. The file system 600, the satellite service 500, and the management service 110 may be separate nodes in communication over a network 351. The method may further include receiving a configuration file 260 at the management service 110 containing the directory path 442. And, the template file 630 and the data file 610 may be stored in different directories along the directory path 442.

According to one embodiment, each of the above steps 1101-1105 may be implemented by a respective software module 331. According to another embodiment, each of the above steps 1101-1105 may be implemented by a respective hardware module 321. According to another embodiment, each of the above steps 1101-1105 may be implemented by a combination of software 331 and hardware modules 321.

While this invention is primarily discussed as a method, a person of ordinary skill in the art will understand that the apparatus discussed above with reference to a data processing system 300 may be programmed to enable the practice of the method of the invention. Moreover, an article of manufacture for use with a data processing system 300, such as a pre-recorded storage device or other similar computer readable medium or computer program product including program instructions recorded thereon, may direct the data processing system 300 to facilitate the practice of the method of the invention. It is understood that such apparatus, products, and articles of manufacture also come within the scope of the invention.

In particular, the sequences of instructions which when executed cause the method described herein to be performed by the data processing system 300 can be contained in a data carrier product according to one embodiment of the invention. This data carrier product can be loaded into and run by the data processing system 300. In addition, the sequences of instructions which when executed cause the method described herein to be performed by the data processing system 300 can be contained in a computer software product or computer program product according to one embodiment of the invention. This computer software product or computer program product can be loaded into and run by the data processing system 300. Moreover, the sequences of instructions which when executed cause the method described herein to be performed by the data processing system 300 can be contained in an integrated circuit product (e.g., a hardware module or modules 321) which may include a coprocessor or memory according to one embodiment of the invention. This integrated circuit product can be installed in the data processing system 300.

The embodiments of the invention described above are intended to be exemplary only. Those skilled in the art will understand that various modifications of detail may be made to these embodiments, all of which come within the scope of the invention.

What is claimed is:

1. A method for processing data files, comprising:
storing a data file and a template file in a file system, the template file containing a command identifier for a command for processing the data file, the template file being stored in a directory in a directory path of the data file, the directory path indicating where the data file is stored in the file system;
receiving a request for a data file to process from a satellite service; and,
forwarding the directory path for the data file to the satellite service in response to the request, the satellite service searching the directory path to locate the data file and the template file, the satellite service calling a program with the command indentified by the command identifier in the template file to process the data file.

2. The method of claim 1 and further comprising receiving an indication from the satellite service when the command has been completed.

3. The method of claim 1 wherein the data file is media file and the command is a media file conversion function.

4. The method of claim 1 and further comprising receiving the data file.

5. The method of claim 1 wherein the program is a command line program.

6. The method of claim 5 wherein the command line program is an external media file conversion program.

7. The method of claim 1 wherein the receiving the request and the forwarding the directory path indicating where the data file is stored are performed by a management service.

8. The method of claim 7 wherein the file system, the satellite service, and the management service are separate nodes in communication over a network.

9. The method of claim 7 and further comprising receiving a configuration file at the management service containing the directory path.

10. The method of claim 1 wherein the template file and the data file are stored in different directories along the directory path.

11. A system for processing data files, comprising:
a processor coupled to memory and an interface to a network; and,
at least one of hardware and software modules within the memory and controlled or executed by the processor, the modules including:
a module for storing a data file and a template file in a file system, the template file containing a command identifier for a command for processing the data file, the template file being stored in a directory in a directory path of the data file, the directory path indicating where the data file is stored in the file system;
a module for receiving a request for a data file to process from a satellite service; and,
a module for forwarding the directory path for the data file to the satellite service in response to the request, the satellite service searching the directory path to locate the data file and the template file, the satellite service calling a program with the command indentified by the command identifier in the template file to process the data file.

12. The system of claim 11 and further comprising a module for receiving an indication from the satellite service when the command has been completed.

13. The system of claim 11 wherein the data file is media file and the command is a media file conversion function.

14. The system of claim 11 and further comprising a module for receiving the data file.

15. The system of claim 11 wherein the program is a command line program.

16. The system of claim 15 wherein the command line program is an external media file conversion program.

17. The system of claim 11 wherein the system is a management service.

18. The system of claim 17 wherein the file system, the satellite service, and the management service are separate nodes in communication over a network.

19. The system of claim 17 and further comprising a module for receiving a configuration file at the management service containing the directory path.

20. The system of claim 11 wherein the template file and the data file are stored in different directories along the directory path.
